(19) United States
(12) Patent Application Publication
(10) Pub. No.: US 2012/0011517 A1
(43) Pub. Date: Jan. 12, 2012

(54) GENERATION OF OPERATIONAL POLICIES FOR MONITORING APPLICATIONS

(76) Inventors: Virginia Smith, Auburn, CA (US); Yuan Chen, Palo Alto, CA (US)

(21) Appl. No.: 12/832,436

(22) Filed: Jul. 8, 2010

(51) Int. Cl. G06F 9/50; G06F 17/00

(52) U.S. Cl. 718/104; 715/224; 718/100

(57) ABSTRACT

Example embodiments relate to generation of operational policies for monitoring applications. In example embodiments, data generated based on decomposition of a Service Level Agreement (SLA) is received. Furthermore, in example embodiments, an operational policy is generated using the decomposition data. The operational policy may be used to control operation of a monitoring application.

### BACKGROUND

A Service Level Agreement (SLA) is a contract that captures the terms of an agreement between a computing service provider and its customer. The terms in such an agreement may include levels of availability, performance, serviceability, and the like. For example, the SLA may specify times at which the system is to be available, maximal response times, the number of users that may be simultaneously served, and other similar metrics. The SLA may also include terms that specify how delivery is measured and consequences should the provider fail to meet the promised terms.

After establishment of an SLA with a customer, a service provider supplies and configures computing resources such that the measurable levels of service defined in the SLA are initially met. Furthermore, during operation of the system, the provider generally monitors system performance to ensure that the system continues to meet the terms of the SLA. Fulfillment of the terms of an SLA is an important goal for a service provider, as the satisfaction of the customer generally depends on adherence to the agreement.

### BRIEF DESCRIPTION OF THE DRAWINGS

In the accompanying drawings, like numerals refer to like components or blocks. The following detailed description references the drawings, wherein:

FIG. 1 is a block diagram of an example policy generation system that uses decomposition data to automatically generate an operational policy for implementation by a monitoring application in real-time;

FIG. 2 is a block diagram of an example policy generation system in communication with an SLA decomposition system to automatically generate operational policies for implementation in real-time by a plurality of monitoring applications;

FIG. 3 is a flowchart of an example method for generating an updated operational policy based on decomposition data;

FIG. 4 is a flowchart of an example method for generating an updated operational policy from a merged policy model derived using a generic policy model and decomposition data; and

FIG. 5 is a block diagram of an example operation flow for generating an operational policy based on decomposition data.

### DETAILED DESCRIPTION

A service provider generally expends a significant amount of effort in configuring and maintaining a computing environment that meets the terms of a Service Level Agreement. In particular, when an SLA is created or modified, an information technology (IT) team must typically analyze the agreement and manually configure a group of monitoring applications to ensure that the terms of the SLA are satisfied. This imposes a significant investment of time and money, as the IT team manually adjusts operational policies to capture the relationship between the SLA and low-level metrics for each monitoring application. Furthermore, when an operational alarm occurs during operation of the monitoring applications, the provider generally spends a significant amount of time and effort in identifying high-level business objectives that are affected (e.g., the identity of the customer, a promised service level, etc.).

To address these issues, example embodiments disclosed herein provide for generation of operational policies based on decomposition of Service Level Agreements (SLAs). In particular, in some embodiments, an example policy generation system receives decomposition data generated based on decomposition of a Service Level Agreement (SLA). Decomposition data may include resource requirements, such as how many servers are required to meet the terms of SLA and healthy bounds of resource utilization for each application component. The policy generation system may then automatically generate an operational policy using the decomposition data. This operational policy may adjust monitoring settings of a monitoring application using resource thresholds included in the decomposition data. The policy generation system may then transmit the operational policy to the monitoring application for implementation of the operational policy in real-time. Furthermore, in some embodiments, the decomposition data includes SLA information, such that the generated operational policy also includes the SLA information.

In this manner, the policy generation system allows for quick application of the policies that control a monitoring application when, for example, a new SLA is established, the terms of the SLA change, or a default workload for a service covered by the SLA changes. Furthermore, because the operational policy may be provided to the monitoring application and implemented in real-time, the system allows for dynamic implementation of a generated policy in a manner that minimizes manual configuration and the need for specialized operator knowledge. Furthermore, by including SLA information in the generated policies, example embodiments allow the provider to quickly identify the affected customer when a monitoring application raises an operational alarm or other alert. Additional embodiments and advantages of such embodiments will be apparent to those of skill in the art upon reading and understanding the following description.

In the description that follows, reference is made to the term, “machine-readable storage medium.” As used herein, the term “machine-readable storage medium” refers to any electronic, magnetic, optical, or other physical storage device that contains or stores executable instructions or other data (e.g., a hard disk drive, flash memory, etc.).

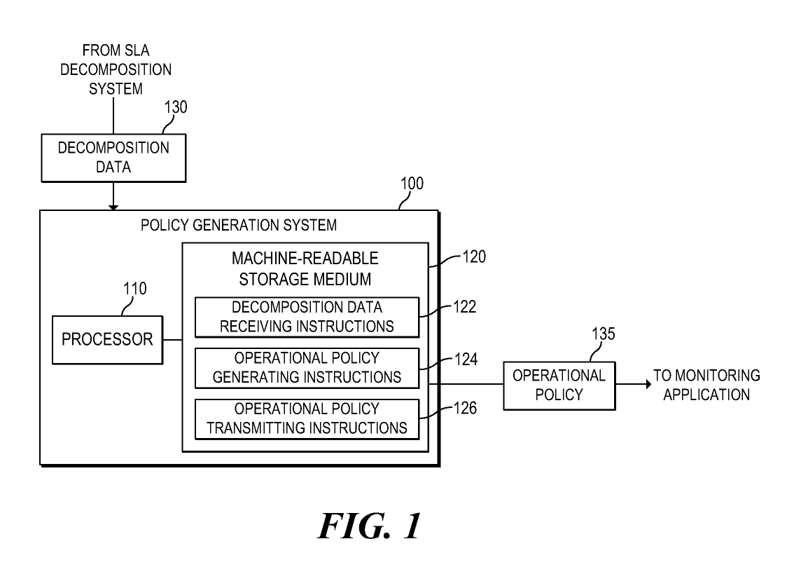

Referring now to the drawings, FIG. 1 is a block diagram of an example policy generation system 100 that uses decomposition data 130 to automatically generate an operational policy 135 for implementation by a monitoring application in real-time. Policy generation system 100 may be, for example, a server, a workstation, a desktop computer, a network management system, or any other computing device suitable for execution of instructions 122, 124, 126. In the embodiment of FIG. 1, policy generation system 100 includes a processor 110 and a machine-readable storage medium 120.

Processor 110 may be one or more central processing units (CPUs), semiconductor-based microprocessors, or other hardware devices suitable for retrieval and execution of instructions stored in machine-readable storage medium 120. In particular, processor 110 may fetch, decode, and execute instructions 122, 124, 126 to implement the functionality described in detail below. Alternatively, processor 110 may be one or more integrated circuits (IC) or other electronic circuits that perform the functionality of instructions 122, 124, 126.

Machine-readable storage medium 120 may include decomposition data receiving instructions 122, which may receive decomposition data 130 generated based on decomposition of a Service Level Agreement. In particular, receiving instructions 122 may receive the decomposition data 130 from an SLA decomposition system that has processed the SLA to generate lower-level system requirements and thresholds.

The SLA to which the decomposition data 130 relates may be a contract or a portion of a contract that formally defines a level of service to be provided to the customer. The SLA may include Service Level Objectives (SLOs), which may describe measurable characteristics of the SLA such as availability (e.g., times when the system is accessible), throughput (e.g., an amount of data per second), and response time (e.g., user request processing time). In addition, the SLA may include a number of details relating to the customer and the service to be provided, such as a customer name or other identifier, a service level, and an identifier for the SLA.

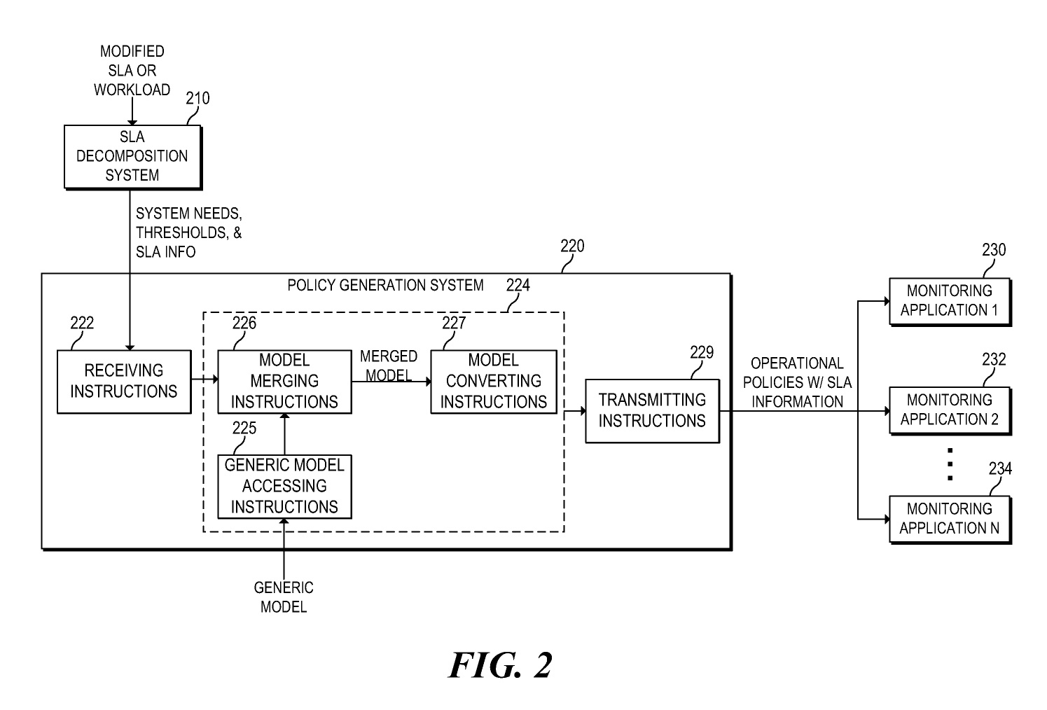

The SLA decomposition system may receive the SLA data and, in response, generate decomposition data 130 based on analysis of the SLA data and associated workloads. To give a specific example, SLA data may indicate a service should support up to 10,000 users and the response time should be less than 5 seconds. Decomposition data 130 may be any set of data that includes resource requirements and thresholds for a system provided for a customer by a service provider to meet the specified SLA. For example, decomposition data 130 may describe parameters that are required to meet the terms of the SLA, such as a number of servers and system-level thresholds relating to the performance of each of the servers (e.g., CPU, memory, and I/O utilization levels). To give a specific example, the decomposition data 130 for a given SLA may indicate that five total servers are required and that the CPU utilization of each server should not exceed 60%, while the memory utilization of each server should not exceed 80%. Additional implementation details for an example SLA decomposition system that derives decomposition data 130 are provided in detail below in connection with FIG. 2.

In some embodiments, decomposition data 130 may also include information describing the SLA. For example, the decomposition data 130 may include an identifier of the Service Level Agreement, which may be, for example, a unique sequence of alphanumeric characters. The decomposition data 130 may also include an identifier of the customer with which the service provider has established the particular SLA (e.g., a customer name, an alphanumeric identifier, etc.). In addition, the decomposition data 130 may include a service level of the customer (e.g., Platinum, Gold, Silver, etc.), which may be assigned to an SLA based, for example, on a service price paid by the customer. Other suitable SLA information items for inclusion in the decomposition data 130 will be apparent to those of skill in the art.

Machine-readable storage medium 120 may also include operational policy generating instructions 124, which may automatically generate an operational policy 135 using the decomposition data 130. In embodiments in which multiple monitoring applications are used to monitor the provisioned system, generating instructions 124 may generate an operational policy for each of the applications. Each operational policy 135 may be used to control the operation of a monitoring application based on the resource thresholds contained in decomposition data 130. For example, the operational policy 135 may be used by each monitoring application to determine which system resources to monitor, predefined ranges for those resources, and what actions should be taken when the monitored resources are outside of the predefined ranges. As another example, an operational policy 135 may configure a monitoring application to capture data relating to a group of defined resources.

In embodiments in which decomposition data 130 includes information describing the SLA, generating instructions 124 may include the information describing the SLA in the generated policy 135 and associated event messages. In such embodiments, the operational policy 135 thereby provides the monitoring application with access to the SLA information. For example, the operational policy 135 may instruct the monitoring application to output a portion of the SLA information upon occurrence of a particular condition. As a specific example, a given operational policy 135 may trigger output of the customer's name and the service level specified in the SLA when a particular resource is operating outside of its healthy range. In this manner, IT personnel may quickly identify the affected customer and a corresponding service level to assist in determining an appropriate response to the alarm.

A number of possible techniques may be used to derive the operational policy 135 for a given monitoring application. For example, operational policy generating instructions 124 may have access to a template or similar data structure that defines the format of an operational policy for a given monitoring application. In addition, operational policy generating instructions 124 may include logic for parsing the decomposition data 130 and processing the parsed data to generate a policy according to the format defined for the particular application.

As a general example of the procedure for generating an operational policy 135, generating instructions 124 may have access to a structured document that includes a number of empty fields that define the data used to generate the policy. Upon receipt of decomposition data 130, generating instructions 124 may insert at least a portion of the decomposition data into the empty fields and, in some embodiments, a number of new fields generated based on the decomposition data. Finally, generating instructions 124 may process the resulting structured document into a format readable by the monitoring application. An example implementation of this procedure using a generic policy model and a merged policy model is described in detail below in connection with operational policy generating instructions 224 of FIG. 2.

Finally, machine-readable storage medium 120 may include operational policy transmitting instructions 126, which may transmit the generated operational policy 135 to the appropriate monitoring application or applications. Upon receipt of the operational policy 135, the particular monitoring application may immediately apply the policy 135 to its operation, such that monitoring of one or more resources based on the thresholds included in the decomposition data 130 begins in real-time. In particular, because operational policy generating instructions 124 derive and output the operational policy 135 upon receipt of the decomposition data 130, a new or modified SLA may be processed and monitored in an efficient manner that minimizes the need for time-consuming manual configuration of the operational policies.

FIG. 2 is a block diagram of an example policy generation system 220 in communication with an SLA decomposition system 210 to automatically generate operational policies for implementation in real-time by a plurality of monitoring applications 230, 232, 234. As illustrated and described in further detail below, SLA decomposition 210 may provide decomposition data to policy generation system 220, which may in turn generate and transmit operational policies to monitoring applications 230, 232, 234.

SLA decomposition system 210 may be a server, a workstation, a desktop computer, a network management system, or any other computing device suitable for execution of an SLA decomposition process. In some embodiments, SLA decomposition system 210 may be the same system as policy generation system 220.

Regardless of the particular implementation, SLA decomposition system 210 may execute a decomposition procedure that may be triggered, for example, upon receipt of a modified SLA or upon modification of a default workload for a service covered by the SLA. For example, a service provider and customer may modify an SLA to change one or more SLOs (e.g., the level of availability, the system throughput, or the response time). Similarly, the decomposition procedure may be triggered when a service provider changes one or more default workloads used in the decomposition process. The default workloads may identify a typical load on the system for a given application (e.g., web server, database, etc.). The default workload may be changed to modify a default number of users of the system and/or a transaction mix (e.g., a rate at which each of a number of types of requests will arrive in the system).

Upon receipt of a modified SLA or workload, SLA decomposition system 210 may execute a procedure to decompose the SLA based on the workload and the SLOs and to output data in the form of system needs, low-level resource thresholds for each component in the system, and SLA information. To derive this information, SLA decomposition system 210 may, for example, use a constraint optimization solver providing, as input, the SLOs, the workload, an analytical performance model, and application resource profiles. The analytical performance model may define the relationship between high level performance goals, the application topology, and the resource usage of each component. The application resource profiles may define, for example, the resource demand of each transaction type on each resource, which may be obtained based on analysis of historical or benchmark data. By constructing and solving a constraint optimization problem using the input data, SLA decomposition system 210 may thereby determine resource requirements (e.g., a number of servers) and low-level system thresholds for those resources. Additional details for implementation of an example SLA decomposition system 210 are provided in the paper, “Systematically Translating Service Level Objectives into Design and Operational Policies for Multi-Tier Applications,” by Yuan Chen et al.

Policy generation system 220 may be, for example, a server, a workstation, a desktop computer, a network management system, or any other computing device suitable for execution of instructions 222, 224-227, 229. Policy generation system 220 may include, for example, a processor (not illustrated) and a machine-readable storage medium that encodes the plurality of instructions 222, 224-227, 229. The processor may be one or more central processing units (CPUs), semiconductor-based microprocessors, or other hardware devices suitable for retrieval and execution of instructions 222, 224-227, 229. Alternatively, the processor may be one or more integrated circuits (IC) or other electronic circuits that perform the functionality of instructions 222, 224-227, 229. The machine-readable storage medium may be any electronic, magnetic, optical, or other physical storage device that contains or stores executable instructions or other data.

In response to modification of an SLA or a default workload and processing by decomposition system 210, receiving instructions 222 may receive updated decomposition data, which may include system needs, resource thresholds for the required resources of the system, and SLA information. This decomposition data may reflect any changes to the system needs (e.g., additional servers), resource thresholds for one or more systems (e.g., lower or higher thresholds), and any changes in the SLA information (e.g., a modified service level).

Operational policy generating instructions 224 may generate an updated operational policy using the updated decomposition data received from SLA decomposition system 210. In particular, as described in detail below, generating instructions 224 may include generic model accessing instructions 225, model merging instructions 226, and model converting instructions 227. Based on execution of these instructions 225, 226, 227, generating instructions 224 may output an operational policy that controls operation of a monitoring application using the resource thresholds.

Generic model accessing instructions 225 may access a generic policy model that describes the operation of a particular monitoring application. For example, the generic policy may be a structured document that includes a plurality of empty fields. This structured document may be, for example, an Extensible Markup Language (XML) document that includes fields relating to a particular monitoring application, such as an application identifier (e.g., web server, database, etc.), details regarding the resources to be monitored (e.g., CPU utilization, disk space, etc.), default thresholds for those resources, and actions to take when the monitored resources trigger conditions relating to the resources.

To give a more specific example of a generic policy, suppose the monitoring application is to monitor a web server for CPU and memory utilization. In this scenario, the generic policy may identify the policy name as, for example, “Web Server Monitoring Policy.” The generic policy may also identify an execution interval defining a time period at which the monitoring application is to capture data from the monitored resource, which, in this case is a web server. For example, the policy may instruct the monitoring application to poll the web server every five minutes to obtain CPU and memory utilization data. In addition, the generic policy may include generic parameters for specific monitoring instances, each of which may relate to one of the resources. Thus, the generic policy may define default parameters for a CPU utilization monitoring policy, such as a default threshold (e.g., 50% utilization) and default actions to take when the threshold is exceeded (e.g., return an alarm to the network management system).

As described above, the generic policy model describes the default parameters that define the operation of a monitoring application, but the generic model is not specific to a particular deployment for a particular customer. To address this, model merging instructions 226 may generate a merged policy model by merging the updated decomposition data received from SLA decomposition system 210 into the generic policy model received by model accessing instructions 225. The merged policy model may be, for example, a structured document for which at least a portion of the decomposition data is inserted into the empty fields in the generic policy model. In addition, the merged policy model may also include a number of new fields generated based on the decomposition data.

The merged policy model may also be an XML document that includes the fields contained in the generic policy model. However, model merging instructions 226 may substitute specific values contained in the decomposition data for the generic parameters in the generic model. For example, model merging instructions 226 may insert the healthy system thresholds derived for the particular SLA into the default threshold fields contained in the generic model, thereby customizing the model for the specific customer deployment. In addition, model merging instructions 226 may also insert the SLA information included in the decomposition data into an empty field in the generic model or, alternatively, may create a new field and insert the data into this field. In this manner, model merging instructions 226 modify the generic policy model to generate a policy that more accurately reflects the SLA information and the low level thresholds that must be satisfied to adhere to the SLA.

Model converting instructions 227 may receive the merged policy model from model merging instructions 226 and, in response, generate the updated operational policy. Model converting instructions 227 may, for example, convert the merged policy model into an operational policy using a script or other executable, such as an Extensible Stylesheet Language (XSL) script. For example, the XSL script or other executable may parse the fields included in the merged policy model and, based on the values of the fields, generate a set of instructions readable by the monitoring application to control its behavior. The generated operational policy may be, for example, a text file defining behavior of the monitoring application.

For example, suppose the monitoring application is a web server, as discussed above. Based on the merged policy model, which now includes details specific to the particular deployment, model converting instructions 227 may generate an operational policy that includes the low-level thresholds and SLA information from the original decomposition data. As an example, the policy may include logic that specifies a condition based on the level of a particular monitored resource and an action to take when the condition is satisfied. For example, an operational policy may instruct the monitoring application to generate an alarm including SLA information (e.g., the customer name and service level) when the CPU utilization exceeds 70%. The final operational policy generated by model converting instructions 227 therefore includes details specific to the particular deployment, thereby minimizing the need for manual configuration of the policies based on the decomposition of the SLA.

Transmitting instructions 229 may, in turn, transmit the updated operational policy to the appropriate monitoring application 230, 232, 234 for implementation in real-time. Upon receipt of the operational policy, which may include the resource thresholds and the SLA information, the particular monitoring application 230, 232, 234 may immediately apply the policy to its operation, such that monitoring of one or more resources for the thresholds identified in the decomposition data begins in real-time.

Monitoring applications 230, 232, 234 may be any of a number of applications, each configured to monitor one or more systems utilized by the service provider in the customer-specific deployment. The behavior of each application 230, 232, 234 in monitoring system resources may be controlled by an operational policy received from policy generation system 220. More specifically, each application 230, 232, 234 may be configured to monitor a set of one or more resource thresholds specified in the operational policy. For example, a given application 230, 232, 234 may monitor a server to track CPU usage, memory usage, disk capacity, and/or a number of other thresholds.

In addition, in some embodiments, each application 230, 232, 234 may be configured to raise an alarm, reconfigure the system, or take another action when a condition contained in an operational policy is met. For example, an operational policy may instruct the monitoring application to raise an alarm when CPU usage exceeds 60% or when the remaining disk space is less than 10%. In response to satisfaction of such a condition, the monitoring application may, for example, send the alarm to a central system which may be policy generation system 220 or another central system for receiving and displaying information from the monitoring applications 230, 232, 234.

As detailed above, each application 230, 232, 234 may be configured to receive an operational policy and, upon receipt, immediately begin monitoring one or more resources based on the operational policy. For example, when a central server (e.g., a network management system) manages the monitoring environment, the server may receive and install the new policy, undeploy any existing policy used by the monitoring application 230, 232, 234, and deploy the new operational policy to the appropriate application. In this manner, upon receipt of a new SLA, a modified SLA, or new default workloads, SLA decomposition system 210 may derive decomposition data and, based on this data, policy generation system 220 may derive and communicate a new operational policy to each monitoring application 230, 232, 234 for implementation in real-time. This implementation therefore allows for each monitoring application 230, 232, 234 to quickly adapt to changing conditions in the deployed system.

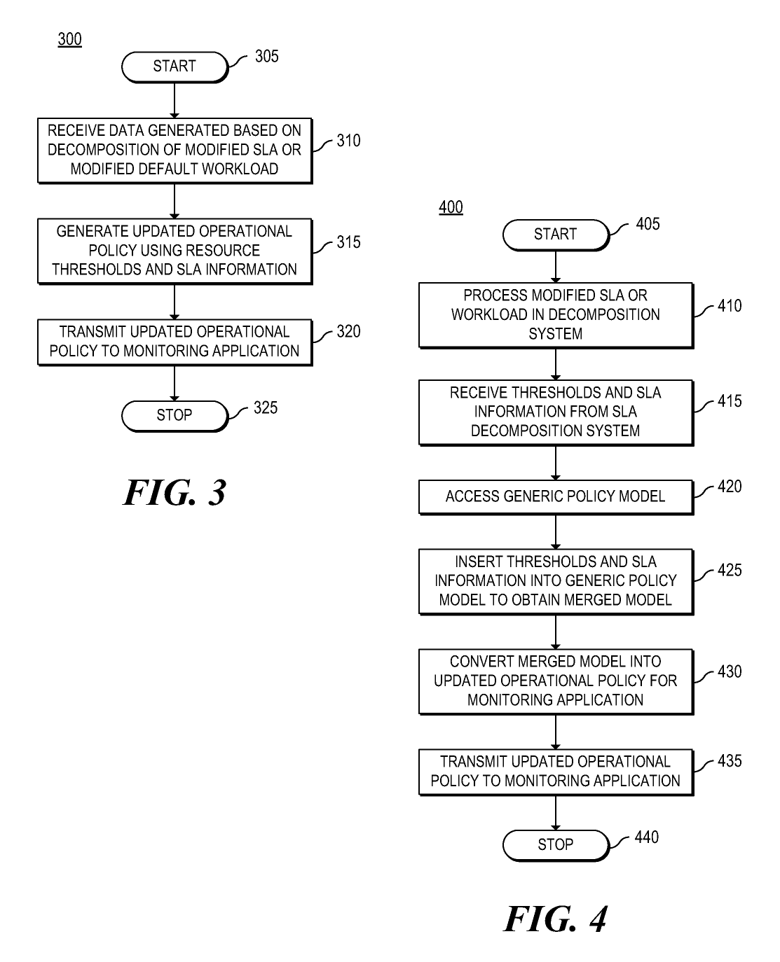

FIG. 3 is a flowchart of an example method 300 for generating an updated operational policy based on decomposition data. Although execution of method 300 is described below with reference to policy generation system 100, other suitable components for execution of method 300 will be apparent to those of skill in the art. Method 300 may be implemented in the form of executable instructions stored on a machine-readable storage medium, such as machine-readable storage medium 120 of FIG. 1.

Method 300 may start in block 305 and proceed to block 310, where policy generation system 100 may receive data generated based on decomposition of a modified Service Level Agreement or modification of a default workload for a service covered by the SLA. In some embodiments, the data received based on the decomposition may include resource thresholds and SLA information. The resource thresholds may describe, for example, a group of system resources and healthy ranges of those resources that, when satisfied, are sufficient to meet the requirements of the SLA. The SLA information may include, for example, an identifier for the particular SLA, an identifier of the customer, and/or a service level of the customer. Additional details describing the receipt of decomposition data are provided above in connection with decomposition data receiving instructions 122 of FIG. 1.

After policy generation system 100 receives the decomposition data, method 300 may proceed to block 315, where policy generation system 100 may generate an updated operational policy for a monitoring application. The generated operational policy may, for example, identify system resources the application is to monitor, healthy ranges for those resources, and what actions should be taken when the monitored resources are outside of the healthy ranges. The operational policy may also include information describing the SLA. For example, the operational policy 135 may instruct the monitoring application to output a portion of the SLA information upon occurrence of a particular condition (e.g., when raising an alarm or otherwise reporting an error). Additional details describing the generation of the operational policy are provided above in connection with operational policy generating instructions 124 of FIG. 1.

Finally, after policy generation system 100 generates the updated operational policy, method 300 may proceed to block 320, where policy generation system 100 may transmit the updated operational policy to the monitoring application for implementation in real-time. Upon receipt of the operational policy, the particular monitoring application may immediately apply the policy to its operation, such that monitoring of one or more resources based on the thresholds included in the decomposition data begins in real-time. Method 300 may then proceed to block 325, where method 300 may stop.

FIG. 4 is a flowchart of an example method 400 for generating an updated operational policy from a merged policy model derived using a generic policy model and decomposition data. Although execution of method 400 is described below with reference to SLA decomposition system 210 and policy generation system 220, other suitable components for execution of method 400 will be apparent to those of skill in the art. Method 400 may be implemented in the form of executable instructions stored on a machine-readable storage medium, such as a machine-readable storage medium included in policy generation system 220.

Method 400 may start in block 405 and proceed to block 410, where SLA decomposition system 210 may process a modified SLA or workload to decompose the SLA into system needs, low-level resource thresholds, and SLA information. The decomposition procedure may be triggered, for example, upon receipt of a modified SLA, such as modification of one or more SLOs (e.g., the level of availability, system throughput, or response time). Similarly, the decomposition procedure may be triggered when a service provider changes a default workload, which may identify a typical load on the system for a given application. Based on receipt of the modified SLA or workload, decomposition system 210 may output the decomposition data to policy generation system 220. An example procedure for performing SLA decomposition based on receipt of a modified SLA or workload is described in detail above in connection with SLA decomposition system 210 of FIG. 2.

After decomposition of the modified data by SLA decomposition system 210, method 400 may proceed to block 415, where policy generation system 220 may receive the decomposition data. As detailed above, the decomposition data may include low-level resource thresholds (e.g., limits on CPU and memory utilization) and SLA information (e.g., an SLA identifier, a customer identifier, and a service level).

Upon receipt of the decomposition data by policy generation system 220, method 400 may proceed to block 420, where policy generation system 220 may access a generic policy model. This policy model may be, for example, a structured document that uses an instantiation of a structured data schema to describe fields relating to a particular monitoring application. For example, the generic policy model may include an application identifier, details regarding the resources to be monitored, default thresholds for those resources, and/or actions to take when the monitored resources are operating outside of the thresholds. Additional details regarding a generic policy model are provided above in connection with generic model accessing instructions 225 of FIG. 2.

After policy generation system 220 retrieves the generic policy model, method 400 may proceed to block 425, where policy generation system 220 may generate a merged policy model. In generating the merged policy model, policy generation system 220 may, for example, insert the resource thresholds and SLA information from the decomposition data into corresponding fields in the generic policy model. In addition, policy generation system 220 may create new fields and insert data from the decomposition data into the created fields. In this manner, policy generation system 220 may modify the generic policy model to generate a merged policy model that reflects the SLA information and the low level thresholds that must be satisfied to adhere to the SLA. Additional details regarding the generation of a merged policy model are provided above in connection with model merging instructions 226 of FIG. 2.

Next, after policy generation system 220 generates the merged policy model, method 400 may proceed to block 430, where policy generation system 220 may convert the merged model into the updated operational policy for a particular monitoring application. Policy generation system 220 may, for example, run a script or other executable to parse the fields included in the merged policy model and, based on the values of these fields, generate a set of instructions readable by the monitoring application to control its behavior. For example, a generated operational policy may instruct the monitoring application to output the SLA information (e.g., the SLA identifier, customer information, or service level) when raising an alert based on operation of the monitored system outside of the resource thresholds. Additional details regarding the generation of the updated operational policy are provided above in connection with model converting instructions 227 of FIG. 2.

After policy generation system 220 generates the updated operational policy, method 400 may proceed to block 435, where policy generation system 220 may transmit the policy to a monitoring application 230, 232, 234. Upon receipt of the operational policy, which may include the resource thresholds and SLA information, the particular monitoring application 230, 232, 234 may immediately apply the policy to its operation. In this manner, monitoring of one or more resources for the thresholds identified in the decomposition data may begin in real-time. Method 400 may then proceed to block 440, where method 400 may stop.

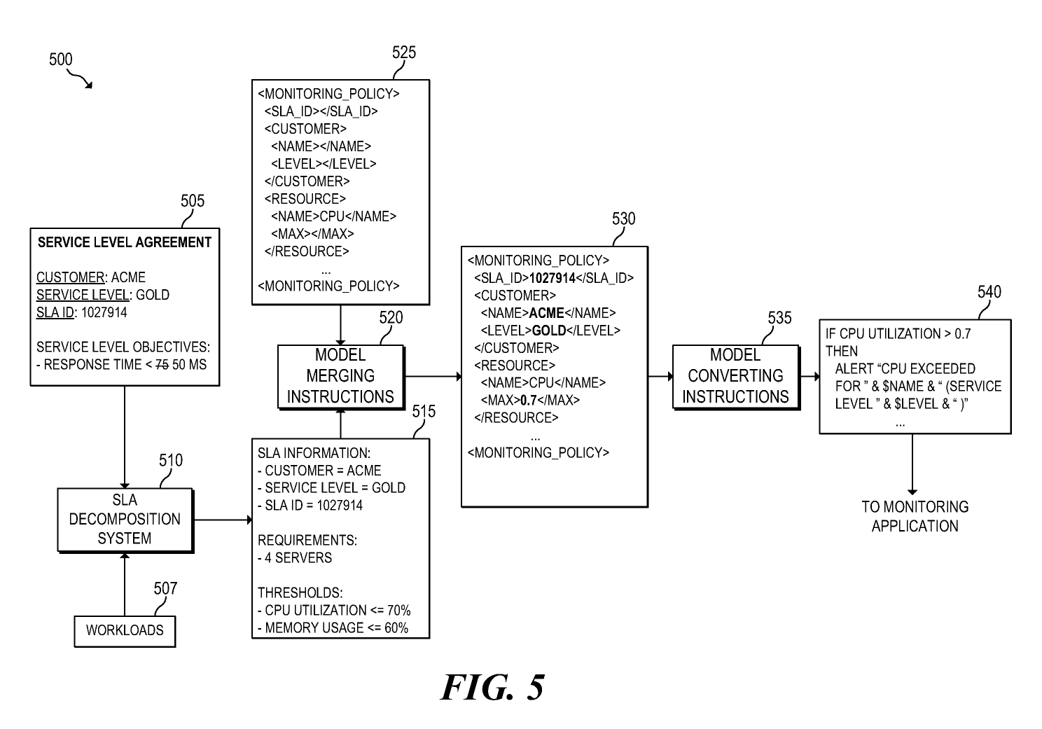

FIG. 5 is a block diagram of an example operation flow 500 for generating an operational policy 540 based on decomposition data 515. Operation flow 500 may begin with processing of SLA 505 and workloads 507 by SLA decomposition system 510. As illustrated, SLA 505, which may be identified as SLA 1027914, indicates that the customer, Acme, has a service level of “Gold” and desires that the response time in the system be reduced from 75 milliseconds to 50 milliseconds.

As described in detail above in connection with SLA decomposition system 210, SLA decomposition system 510 may receive notification of the modified SLA 505 and, in response, process the SLA 505 along with workloads 507 to determine system needs and low-level resource thresholds for each component required in the system. As illustrated, SLA decomposition system 510 has generated decomposition data 515, which includes the SLA information (the customer name, service level, and SLA ID). In addition, decomposition data 515 indicates that 4 total servers are required to meet the customer's needs. Furthermore, decomposition data 515 indicates that CPU utilization in each server should remain at or below 70%, while memory usage should remain at or below 60%.

Based on receipt of decomposition data 515, model merging instructions 520 may also retrieve generic policy model 525. As illustrated, generic policy model 525 may be a structured document that defines fields for the SLA ID, customer name, and service level. In addition, generic policy 525 may include a resource monitoring item related to the CPU and may include an empty field for storing the maximum CPU utilization. Based on the fields included in generic policy 525 and the corresponding information included in decomposition data 515, model merging instructions 520 may generate merged policy model 530.

As illustrated, merged policy model 530 may include a structure similar to generic policy model 525 with additional data from decomposition data 515. Here, the field <SLA_ID> has been populated with the SLA ID, 1027914. In addition, the field <NAME> has been populated with “ACME,” while the field <LEVEL> has been populated with “GOLD.” Finally, the <MAX> field indicating the maximum CPU utilization has been populated with “0.7.”

After generation of merged policy model 530, model converting instructions 535 may process the data included in merged policy model 530 to generate operational policy 540. As illustrated, operational policy 540 may include a condition instructing the monitoring application to raise an alarm when the CPU utilization exceeds the value included in decomposition data 515, 70%. In addition, operational policy 540 instructs the application to include the customer name and service level in the alarm raised upon satisfaction of this condition. After generation of operational policy 540 by model converting instructions 535, operational policy 540 may be transmitted to the monitoring application for implementation in real-time.

According to the foregoing, example embodiments disclosed herein provide for generation of an operational policy based on decomposition of Service Level Agreements. In particular, example embodiments described above allow for real-time implementation of an operational policy in a manner that minimizes manual configuration and the need for specialized operator knowledge. Furthermore, by including SLA information in the generated policies, example embodiments allow the provider to quickly identify the affected customer and business interests when a monitoring application raises an operational alarm or other alert.

We claim:

1. A policy generation system comprising:
a processor to:
receive decomposition data generated based on decomposition of a Service Level Agreement (SLA), the decomposition data comprising resource thresholds,
generate an operational policy using the decomposition data, wherein the operational policy controls operation of a monitoring application using the resource thresholds, and
initiate transmission of the operational policy to the monitoring application for implementation of the operational policy in real-time.

2. The policy generation system of claim 1, wherein, to generate the operational policy, the processor:
accesses a generic policy model that describes operation of the monitoring application,
merges the decomposition data into the generic policy model to obtain a merged policy model, and
converts the merged policy model into the operational policy for the monitoring application.

3. The policy generation system of claim 2, wherein:
the generic policy model is a structured document comprising a plurality of empty fields,
the merged policy model is a structured document for which at least a portion of the decomposition data is inserted into the plurality of empty fields and at least a portion of the decomposition data is inserted into new fields generated based on the decomposition data, and
the operational policy is a file defining behavior of the monitoring application based on the merged policy model.

4. The policy generation system of claim 1, wherein:
the decomposition data further includes information describing the SLA, and
to generate the operational policy, the processor inserts the information describing the SLA into the operational policy for the monitoring application.

5. The policy generation system of claim 4, wherein the information describing the SLA inserted by the processor into the operational policy includes at least one of an identifier for the SLA, an identifier for a customer, and a service level for the customer.

6. The policy generation system of claim 4, wherein the operational policy generated by the processor instructs the monitoring application to output the information describing the SLA upon occurrence of a specified condition.

7. A machine-readable storage medium encoded with instructions executable by a processor of a computing device, the machine-readable storage medium comprising:
instructions for receiving, in response to a modification of a Service Level Agreement (SLA) or modification of a default workload for a service covered by the SLA, updated decomposition data generated based on decomposition of the SLA, the updated decomposition data including resource thresholds;
instructions for generating an updated operational policy using the updated decomposition data, wherein the updated operational policy controls operation of a monitoring application using the resource thresholds; and
instructions for transmitting the updated operational policy to the monitoring application during operation of the monitoring application for implementation in real-time.

8. The machine-readable storage medium of claim 7, wherein the instructions for generating the updated operational policy comprise:
instructions for accessing a generic policy model that describes operation of the monitoring application,
instructions for merging the updated decomposition data into the generic policy model to obtain a merged policy model, and
instructions for converting the merged policy model into the updated operational policy for the monitoring application.

9. The machine-readable storage medium of claim 7, wherein the modification of the SLA includes modification of a Service Level Objective (SLO).

10. The machine-readable storage medium of claim 7, wherein:
the updated decomposition data further includes SLA information comprising at least one of an identifier for the SLA, an identifier for a customer, and a service level, and
the instructions for generating the updated operational policy insert the SLA information into the updated operational policy.

11. A method comprising:
receiving, in a policy generation system, data generated by a decomposition procedure triggered by modification of a Service Level Agreement (SLA) or modification of a default workload for a service covered by the SLA, the data including resource thresholds and SLA information;
deriving an updated policy model using the resource thresholds and the SLA information; and
generating an updated operational policy that controls operation of a monitoring application using the updated policy model, wherein the updated operational policy instructs the monitoring application to monitor the resource thresholds and includes the SLA information.

12. The method of claim 11, further comprising:
transmitting the updated operational policy to the monitoring application for implementation in real-time by the monitoring application.

13. The method of claim 11, wherein the deriving comprises:
accessing a generic policy model that uses an instantiation of a structured data schema including resource threshold fields and SLA information fields; and
inserting the resource thresholds and the SLA information into the fields in the generic policy model to obtain the updated policy model.

14. The method of claim 11, wherein the SLA information comprises at least one of an SLA identifier, customer information, and service level information.

15. The method of claim 14, wherein the updated operational policy instructs the monitoring application to output at least one of the SLA identifier, the customer information, and the service level information when raising an alert based on operation of a monitored system outside of the resource thresholds.
